(19) United States
(12) Patent Application Publication
(10) Pub. No.: US 2007/0095555 A1
(43) Pub. Date: May 3, 2007

(54) Cable assembly and method of preparing cable assembly

(76) Inventor: John T. Venaleck, Painesville, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/581,617

(22) Filed: Oct. 16, 2006

Related U.S. Application Data
(60) Provisional application No. 60/731,607, filed on Oct. 28, 2005.

(51) Int. Cl. H01R 9/05

(52) U.S. Cl. 174/75 C

(57) ABSTRACT

A cable assembly includes a plurality of coaxial cables and a pair of conductive material ribbons or strips that are placed on opposite sides of the cables, and that are soldered to conductive shields of the cables. The ribbons may mechanically couple a plurality of cables together in a desired configuration, for example with all the cables being substantially evenly spatially separated from one another. In addition, the conductive ribbon electrically links the shields of all the cables together. Thus the use of the conductive ribbons facilitates making electrical connection to the braided or served shields of the cables. The conductive ribbons may be made of a suitable electrically conductive material, such as copper.

This application claims priority under 35 USC 119 from U.S. Provisional application Ser. No. 60/731,607, filed Oct. 28, 2005, which is herein incorporated by reference in its entirety.

### BACKGROUND OF THE INVENTION

1. Technical Field of the Invention

This invention is in the field of cable assemblies for use in high-speed electronic devices such as computers, and in methods of fabricating such devices.

2. Description of the Related Art

The high-speed computer industry makes use of coaxial cables for the transmission of high-frequency signals. When many cables are required, it is advantageous to handle multiples of the cables simultaneously. To this end, manufacturers have prepared a product with cables bonded side by side to form a ribbon of coaxial cables. This ribbon cable configuration allows for simultaneously handling as many cables as are bonded together. Termination of the cables can be done in a step-and-repeat planar fashion. However, equipment for simultaneously stripping the ends of ribbons of coaxial cables is unavailable, although equipment for stripping one or both ends of a single cable is readily available. This lack of a convenient way of stripping ends of ribbons of coaxial cable makes use of such ribbon cables problematic.

In addition, some kinds of coaxial cables, such as cables with braided shields or cables having served shields, utilize a multiplicity of fine wires for their shielding. Such shields lack mechanical unity, and are thus not suitable for welding to cable terminations.

From the foregoing it will be appreciated that improved methods are desirable with regard to high-speed cables and method of making assemblies of such cables.

### SUMMARY OF THE INVENTION

According to another aspect of the invention, a method of making a cable assembly includes placing coaxial cables between a pair of solder-coated conductive material ribbons, and heating the cables and/or ribbons to solder together the coaxial cables and the ribbons.

According to still another aspect of the invention, a cable assembly includes plural coaxial cables, each including conductive shielding consisting of many fine wires. The conductive shielding of the cables are secured to a conductive material ribbon or strip.

According to a further aspect of the invention, a cable assembly includes plural cables having ends placed in half-cylindrical portions of a conductive material ribbon or strip. The cable ends are soldered or otherwise secured to the conductive material strips.

According to a still further aspect of the invention, a cable assembly includes: a plurality of coaxial cables, each including a signal conductor circumferentially surrounded by a conductive shield; and a pair of ribbons of conductive material attached to the shields of coaxial cables.

According to another aspect of the invention, a method of forming a cable assembly, the method includes: stripping portions of a plurality of coaxial cables, to thereby expose conductive shielding of the cables, wherein for each of the cables the exposed conductive shielding surrounds a signal conductor of the cable; placing the exposed conductive shielding of the cables between a pair of conductive ribbons; and attaching the exposed conductive shielding to the conductive ribbons, thereby forming the cable assembly.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWINGS

In the annexed drawings, which are not necessarily to scale:

FIG. 1 shows an oblique view of a cable assembly in accordance with the present invention;

FIG. 2 shows an exploded view of the cable assembly of FIG. 1;

FIG. 3 shows an oblique view of a conductive ribbon used in the cable assembly of FIG. 1;

FIG. 4 is a high-level flowchart showing steps in the manufacture of the cable assembly of FIG. 1;

FIGS. 5 and 6 are oblique views illustrating operations in the method of FIG. 4;

FIG. 7 is an oblique view illustrating connection of the cable assembly of FIG. 1 to an electrical connector; and

FIG. 8 is an oblique view of an alternate embodiment of the cable assembly in accordance with the present invention, with a plurality of cables linked by conductive ribbons at both ends of the cables.

### DETAILED DESCRIPTION

A cable assembly includes a plurality of coaxial cables and a pair of conductive material ribbons or strips that are placed on opposite sides of the cables, and that are soldered to conductive shields of the cables. The ends of the cables are stripped in order to expose portions of a central signal conductor and a conductive shield that circumferentially surrounds the central signal conductor. The stripped portions are placed between the conductive material ribbons, with the shield portions of the stripped ends in contact with the conductive ribbons. The conductive ribbons may have suitable depressions or indentations, such as substantially half-cylindrical shaped indentations, to better secure the stripped ends of the cables, and to maintain the cables in a predetermined spaced configuration. For instance, the cables may be substantially parallel to one another, and may be evenly spaced from one another. The conductive ribbons may be substantially identical to one another, and may form a series of holes or pockets in which individual of the cables are substantially surrounded. One side of each of the conductive ribbons, the side in contact with the shield material of the cables, may be coated with solder. After the cables have been placed between the conductive material ribbons, the conductive ribbons and/or the cable ends may be heated to melt and reflow the solder, thereby soldering the conductive ribbons to the shields of the coaxial cables. The ribbons may thus mechanically couple a plurality of cables together in a desired configuration, for example with all the cables being substantially evenly spatially separated from one another. In addition, the conductive ribbon electrically links the shields of all the cables together. The conductive ribbons may be coupled to other contacts or shield plates, such as by a welded connection with the conductive ribbon. Thus the use of the conductive ribbons facilitates making electrical connection to the braided or served shields of the cables. The conductive ribbons may be made of a suitable electrically conductive material, such as copper. The conductive ribbons may have suitable cable-receiving portions, for example, substantially half-cylindrical portions, between flat portions that are used to separate adjacent of the cables. Both of the conductive ribbons may be substantially identical, and both may be coated on one side with a coating of solder.

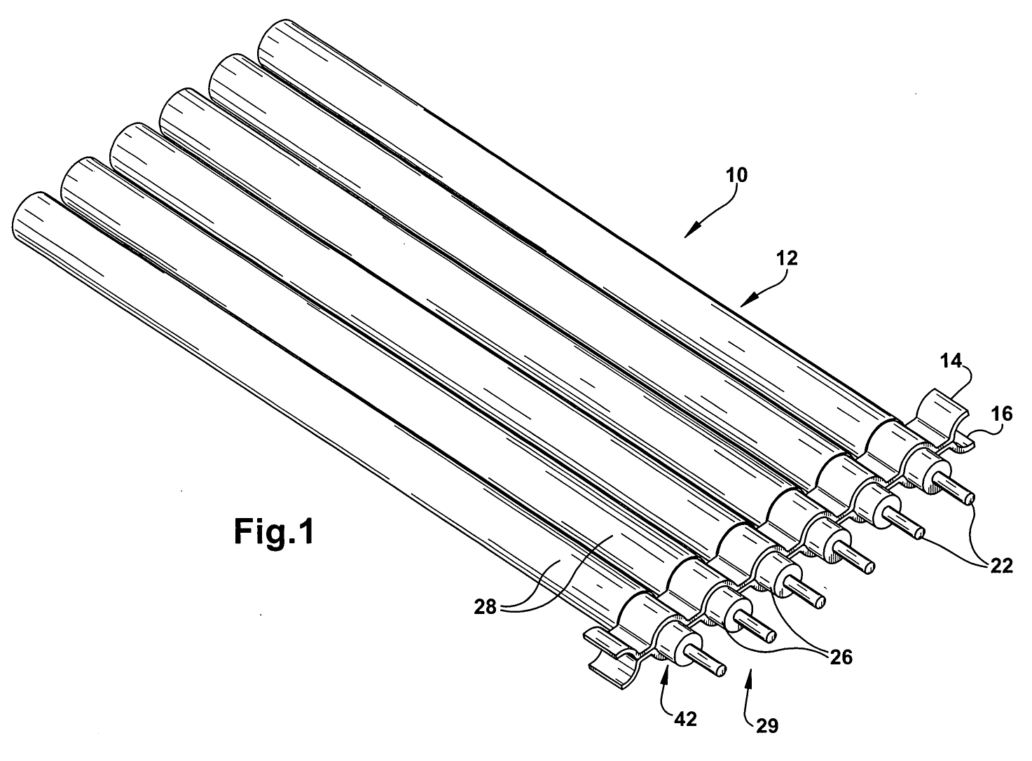

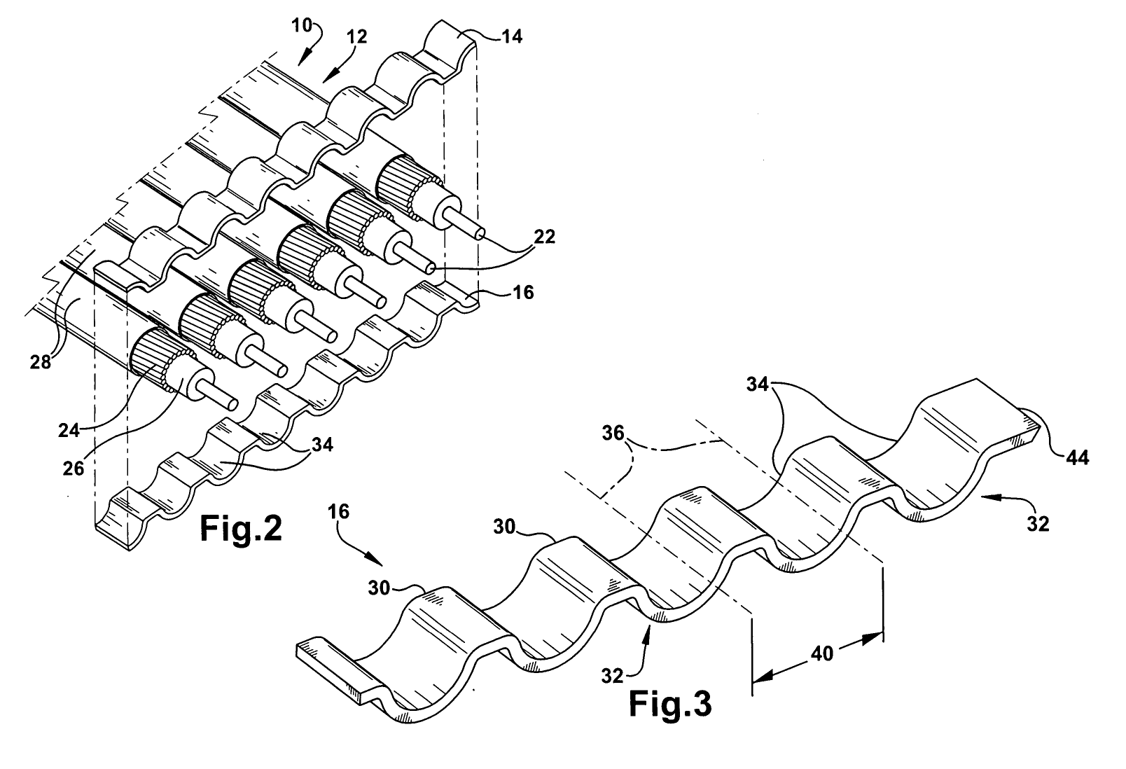

FIGS. 1 and 2 show a cable assembly 10 that includes a plurality of cables 12 joined together by conductive ribbons 14 and 16. The cables 12 are coaxial cables, each including a signal wire 22 and conductive shielding 24 circumferentially surrounding the signal wire 22. An inner insulation layer 26 separates the signal wire 22 from the conductive shield 24. Outer insulation 28 surrounds the conductive shielding 24 and makes an outer casing for the cable 12. The conductive shielding 24 may consist of a multitude of fine wires twisted or braided together. Thus, the cables 12 may be cables with braided shields or served shields. Any of a variety of sizes of cables may be used.

The conductive ribbons 14 and 16 mechanically and electrically couple together stripped ends 29 of the cables 12. The ribbons 14 and 16 mechanically couple the cables together in a desired spacing relative to one another. The ribbons 14 and 16 also electrically couple together portions of the shields 24 of the cables 12.

FIG. 3 shows a more detailed view of the configuration of one of the ribbons, the lower ribbon 16. The upper ribbon 14 may be substantially identical to the lower ribbon 16. The ribbon 16 may be formed from a rectangular sheet of a conductive material, for example, from suitable sheet copper having a thickness of from 0.005 to 0.015 inches (0.13 to 0.38 mm). The ribbon 16 has a plurality of flat portions 30 interspersed between a plurality of depressions or indentations 32. The depressions 32 may be substantially half-cylindrical, cable-receiving portions 34, defining axes 36. The axes 36 of adjacent of the depressions 32 may be spaced apart with spacing 40. The ribbons 14 and 16 may line up with their respective flat portions 30 in contact with one another. The substantially half-cylindrical portion 34 of the ribbons 14 and 16 may thereby define a plurality of cable-receiving cylindrical openings 42 (FIG. 1). The half-cylindrical portions 34 of the ribbons 14 and 16 may substantially surround the inserted portions (stripped ends) of the cable 12. The cable-receiving portions 34 may substantially surround the stripped ends of each of the cables 12.

Each of the ribbons 14 and 16 may have a solder layer 44 on one side thereof, the concave side of the half-cylindrical, cable-receiving portions 34. Once the stripped ends 29 of the cables 12 are placed between the ribbons 14 and 16, the ribbons 14 and 16 and/or the stripped ends 29 are heated to cause the solder layer 44 to melt and reflow partially into the conductive shield material 24 of the cables 12. After subsequent cooling, the solder solidifies again, making a mechanical and electrical bond between the conductive ribbons 14 and 16 and the conductive shield material 24 of the cables 12. In addition, the soldering may mechanically couple together the conductive ribbons 14 and 16, for example, by soldered connections made between the flat portion 30 of one of the conductive ribbons, and the flat portion 30 of the other of the conductive ribbons.

The solder layer 44 on the conductive ribbons 14 and 16 may have any of a wide variety of suitable solder materials, using any of a variety of suitable commercially-available solder alloys. The conductive ribbons 14 and 16 may be made by stamping or by other suitable processes.

The conductive ribbons 14 and 16 allow for secure evenly-spaced placement of the ends 29 of the cables 12, substantially parallel to one another. The conductive ribbons 14 and 16 also provide a way to electrically link together the shields 24 of the various cables 12, and provide as well a way of making electrical connection, such as a welded electrical connection, to the shields 24.

It will be appreciated that the illustrated embodiment of the cable assembly 10, with the cables 12 substantially evenly spaced from one another, is but one possible configuration for the cable assembly 10. It will be appreciated that many other spacings of the cables 12 may be obtained by suitably shaped conductive ribbons. The broad concept of securing coaxial cables between a pair of conductive elements made by applied in any of a wide variety of other suitable configurations.

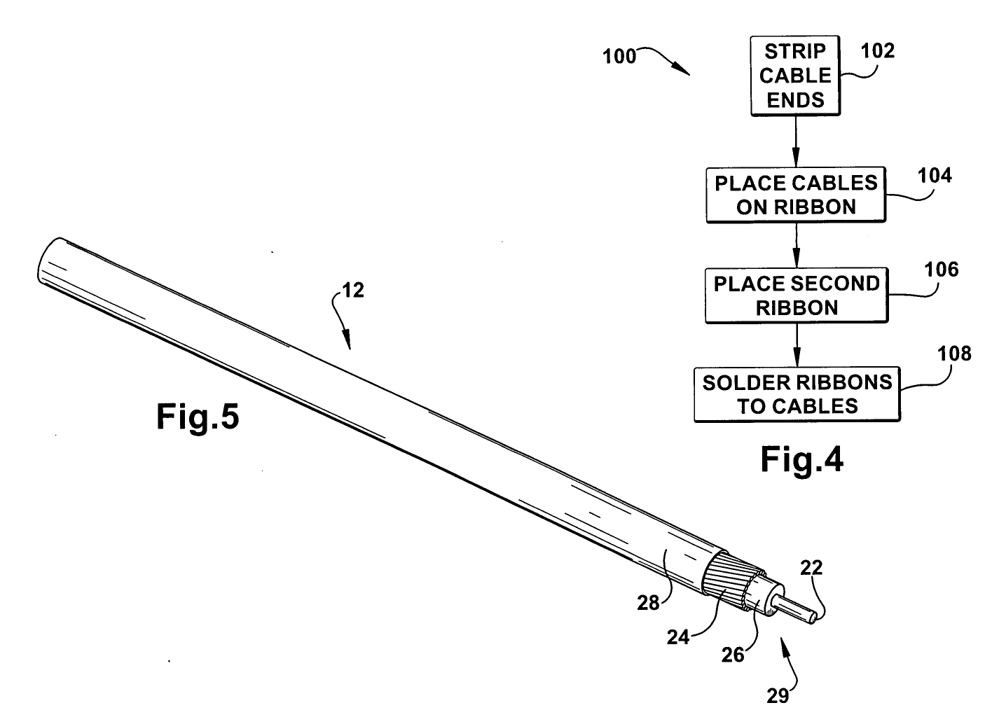

FIG. 4 shows a flowchart of a method 100 for assembling the cable assembly 10 (FIG. 1). First, in step 102, the ends 29 of a plurality of coaxial cables 12 are stripped. FIG. 5 shows a single cable 12 with an end 29 stripped to expose portions of the conductive shield 24, and the signal wire 22. It will be appreciated that suitable machines for stripping ends of coaxial cables are well known.

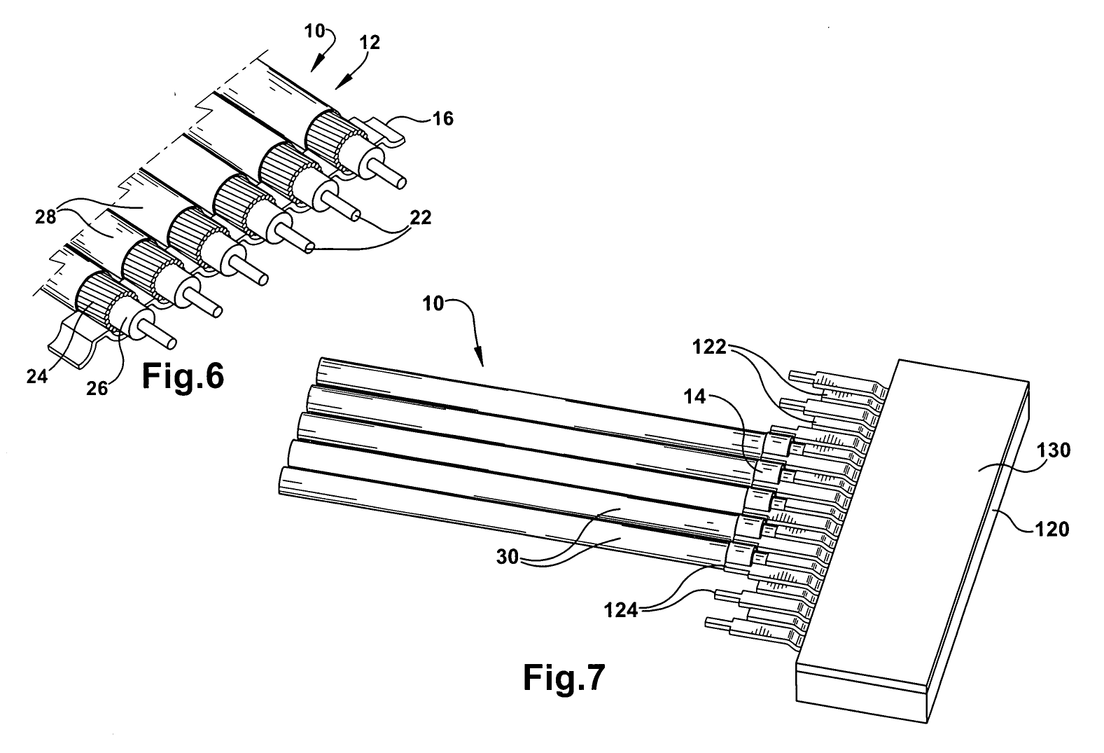

Thereafter, in step 104 a plurality of the stripped cables 12 are placed on a lower conductive ribbon 16, as illustrated in FIG. 6. The stripped ends 29 of the cable 12 are placed in the cable-receiving portions 34 of the lower conductive ribbon 16 such that the conductive shielding 24 of the cables 12 is in contact with the solder layer 44 of the lower conductive ribbon 16. Then the top conductive ribbon 14 is placed on the stripped ends 29 in step 106, and the conductive ribbons 14 and 16 are clamped or otherwise fixtured together. Then, in step 108, heating is applied to melt and reflow the solder from the solder layers 44 of the conductive ribbons 14 and 16. The soldering may be by any suitable soldering method, such as conformal hot bar soldering.

Referring now to FIG. 7, the cable assembly 10 is shown being coupled to a connector 120 by a step-and-repeat automatic welding process. The signal wires 22 of the individual cables 12 of the cable assembly 10 are evenly spaced, and can be terminated by welding to evenly-spaced signal conductors 122 of the connector 120. Shield contacts 124 of a conductive shield 130 of the connector 120 can be welded to the flat portions 30 of one of the conductive ribbons 14 and 16. The uniform spacing of the signal wires 22 and the flat portions 30 facilitates use of step-and-repeat automatic welding.

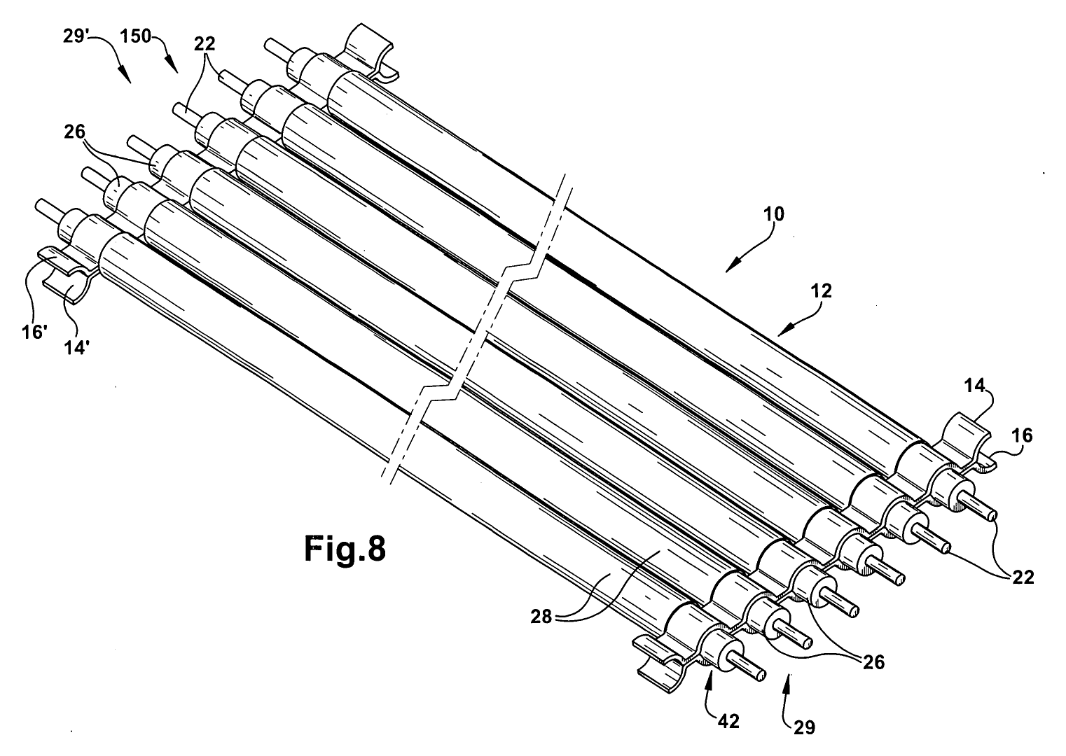

FIG. 8 shows a variation of the cable assembly 10 in which both ends 140 and 150 of the cable assembly 10 are joined together with respective pairs of conductive ribbons 14, 16 and 14′, 16′. It will be appreciated that the same steps described above for stripping the ends 29 and 29′ of the cables 12, and for applying the conductive ribbons 14 and 16 to the ends 29 and 29′ of the cables 12, may also be employed to apply the conductive ribbons 14′ and 16′ to opposite ends 29 and 29′ of the cables 12.

The cable assembly 10 and the method 100 provide an effective way to utilize existing machinery for stripping single coaxial cables, to produce cable assemblies that can be reliably secured to electrical connectors using automatic step-and-repeat weld processes. The use of the conductive ribbons 14 and 16 provides both a reliable way of mechanically securing the stripped ends 29 of the cables together, but also provides a way of easily making electrical connections to the fine-wire conductive shields 24 of the cables 12.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A cable assembly comprising:
a plurality of coaxial cables, each including a signal conductor circumferentially surrounded by a conductive shield; and
a pair of ribbons of conductive material attached to the shields of coaxial cables.

2. The cable assembly of claim 1,
wherein the cables are substantially parallel to one another where the cables are attached to the ribbons of conductive material, thereby defining a cable plane; and
wherein the ribbons are attached to the shields of the cables on opposite respective sides of the cable plane.

3. The cable assembly of claim 2, wherein the ribbons each have a plurality of depressions for receiving the cables and maintaining the cables consistently spaced from one another.

4. The cable assembly of claim 3, wherein the depressions include substantially half-cylindrical cable-receiving portions.

5. The cable assembly of claim 4, wherein the ribbons each have flat portions between adjacent of the half-cylindrical cable-receiving portions.

6. The cable assembly of claim 1, wherein the ribbons substantially enclose portions of the cables, and maintain the cables spaced from one another at a substantially uniform spacing.

7. The cable assembly of claim 1, wherein the ribbons are sheet copper ribbons.

8. The cable assembly of claim 1, wherein the ribbons are soldered to the shields of the cables.

9. The cable assembly of claim 1, wherein the shields of the cables each include a plurality of wires of conductive material.

10. The cable assembly of claim 9, wherein the shields are braided shields.

11. The cable assembly of claim 9, wherein the shields are served shields.

12. The cable assembly of claim 1,
wherein the pair of ribbons are attached to the shields at first ends of the cables; and
further comprising a second pair of ribbons of conductive material at second ends of the cables.

13. The cable assembly of claim 1, in combination with an electrical connector,
wherein signal conductors of the cables are attached to signal conductors of the connector; and
wherein at least one of the ribbons is attached to a conductive shield of the connector.

14. The combination of claim 13, wherein the conductive shield of the connector is attached to the at least one of the ribbons by a welded connection.

15. A method of forming a cable assembly, the method comprising:
stripping portions of a plurality of coaxial cables, to thereby expose conductive shielding of the cables, wherein for each of the cables the exposed conductive shielding surrounds a signal conductor of the cable;
placing the exposed conductive shielding of the cables between a pair of conductive ribbons; and
attaching the exposed conductive shielding to the conductive ribbons, thereby forming the cable assembly.

16. The method of claim 15, wherein the placing includes:
placing the cables in respective depressions in one of the ribbons; and
placing the other of the ribbons on top of the cables.

17. The method of claim 16, wherein the depressions in the one of the ribbons include substantially half-cylindrical cable-receiving portions of the one of the ribbons.

18. The method of claim 15, wherein the attaching includes soldering the conductive ribbons to the conductive shields.

19. The method of claim 18,
wherein the placing includes placing the exposed conductive shielding in contact with solder coatings on faces of the conductive ribbons; and
wherein the soldering includes melting the solder coatings of the conductive ribbons.

20. The method of claim 15, wherein the placing includes placing the cables substantially parallel to one another and substantially evenly spaced from one another, between the conductive ribbons.
